(19) United States
(12) Patent Application Publication
(10) Pub. No.: US 2020/0293908 A1
(43) Pub. Date: Sep. 17, 2020

(54) PERFORMING DATA PROCESSING BASED ON DECISION TREE

(71) Applicant: Alibaba Group Holding Limited, George Town (KY)

(72) Inventors: Lichun LI, Hangzhou (CN); Jinsheng Zhang, Hangzhou (CN); Huazhong Wang, Hangzhou (CN)

(73) Assignee: Alibaba Group Holding Limited, George Town (KY)

(21) Appl. No.: 16/890,850

(22) Filed: Jun. 2, 2020

Related U.S. Application Data
(63) Continuation of application No. 16/779,285, filed on Jan. 31, 2020.
Application No. 16/779,285 is a continuation of application No. PCT/CN2020/071586, filed on Jan. 11, 2020.

(30) Foreign Application Priority Data
Jul. 1, 2019 (CN) 201910583556.0

(51) Int. Cl. G06N 5/00; G06N 5/04

(52) U.S. Cl. CPC G06N 5/003; G06N 5/04

(57) ABSTRACT

Disclose herein are methods, systems, and apparatus, including computer programs encoded on computer storage media, for data processing. One of the methods includes: determining, by a first computing device based on service data possessed by the first computing device, whether a leaf value of a leaf node of a decision tree at least possibly matches information included in the service data; in response to determining that the leaf value at least possibly matches the information included in the first service data, determining; a first data selection value corresponding to the leaf node; and performing oblivious transfer with a second computing device that processes a decision tree model of the decision tree by using the first data selection value as an input to obtain first target data for determining a prediction result of the decision forest.

### CROSS-REFERENCE TO RELATED APPLICATIONS

This application is a continuation of U.S. patent application Ser. No. 16/779,285, filed on Jan. 31, 2020, which is a continuation of PCT Application No. PCT/CN2020/071586, filed on Jan. 11, 2020, which claims priority to Chinese Patent Application No. 201910583556.0, filed on Jul. 1, 2019, and each application is hereby incorporated by reference in its entirety.

### TECHNICAL FIELD

Implementations of the present specification relate to the field of computer technologies, and in particular, to a data processing method and device, and an electronic device.

### BACKGROUND

During service implementation, generally, one party usually has a model that needs to be kept secret and at least a portion of service data (hereafter referred to as a model owner), and the other party has another part of all service data that needs to be kept secret (hereafter referred to as a data owner). A technical problem that needs to be urgently resolved is to enable the model owner and/or the data owner to obtain a prediction result obtained by predicting all service data based on a model while the model owner does not disclose the model and service data of the model owner and the data owner does not disclose the service data of the data owner.

### SUMMARY

An object of implementations of the present specification is to provide a data processing method and device, and an electronic device, so that a model owner and/or a data owner obtain/obtains a prediction result obtained by predicting all service data based on a model while the model owner does not disclose model data and/or service data of the model owner and the data owner does not disclose service data of the data owner.

To achieve the previous object, one or more implementations of the present specification provide the following technical solutions:

According to a first aspect of one or more implementations of the present specification, a data processing method is provided, applied to a model owner and including: selecting a burst node associated with service data of a data owner from a decision forest as a target burst node, where the decision forest includes at least one decision tree, and the decision tree includes at least one burst node and at least two leaf nodes; and sending the splitting criteria of the target burst node to a data owner, and saving splitting criteria of other burst nodes other than the target burst node and a leaf value of each leaf node.

According to a second aspect of one or more implementations of the present specification, a data processing device is provided, applied to a model owner and including: a selection unit, configured to select a burst node associated with service data of a data owner from a decision forest as a target burst node, where the decision forest includes at least one decision tree, and the decision tree includes at least one burst node and at least two leaf nodes; and a sending unit, configured to send the splitting criterion of the target burst node to a data owner, and save splitting criteria of other burst nodes other than the target burst node and a leaf value of each leaf node.

According to a third aspect of one or more implementations of the present specification, an electronic device is provided, including: a memory, configured to store computer instructions; and a processor, configured to execute the computer instructions to implement method steps according to the first aspect.

According to a fourth aspect of one or more implementations of the present specification, a data processing method is provided, applied to a model owner, where the model owner has service data, and the method includes: analyzing, based on the service data, a possibility that a leaf node in a decision forest can be matched, where the decision forest includes at least one decision tree, and the decision tree includes at least one burst node and at least two leaf nodes; if it is possible that the leaf node can be matched, determining a first data set corresponding to the leaf node, where the first data set includes a random number and a leaf value ciphertext; and performing oblivious transfer with a data owner by using the first data set as an input.

According to a fifth aspect of one or more implementations of the present specification, a data processing device is provided, applied to a model owner, where the model owner has service data, and the device includes: an analysis unit, configured to analyze, based on the service data, a possibility that a leaf node in a decision forest can be matched, where the decision forest includes at least one decision tree, and the decision tree includes at least one burst node and at least two leaf nodes; a determining unit, configured to: if it is possible that the leaf node can be matched, determine a first data set corresponding to the leaf node, where the first data set includes a random number and a leaf value ciphertext; and a transfer unit, configured to perform oblivious transfer with a data owner by using the first data set as an input.

According to a sixth aspect of one or more implementations of the present specification, an electronic device is provided, including: a memory, configured to store computer instructions; and a processor, configured to execute the computer instructions to implement method steps according to the fourth aspect.

According to a seventh aspect of one or more implementations of the present specification, a data processing method is provided, applied to a data owner, where the data owner has service data and a splitting criterion corresponding to a burst node associated with the service data in a decision forest, the decision forest includes at least one decision tree, the decision tree includes at least one burst node and at least two leaf nodes, and the method includes: analyzing, based on the service data and the splitting criterion, a possibility that a leaf node in the decision forest can be matched; if it is possible that the leaf node can be matched, determining a first data selection value corresponding to the leaf node; and performing oblivious transfer with a model owner by using the first data selection value as an input, to obtain first data as target data, where the target data is used to determine a prediction result of the decision forest.

According to an eighth aspect of one or more implementations of the present specification, a data processing device is provided, applied to a data owner, where the data owner has service data and a splitting criterion corresponding to a target burst node, the target burst node is a burst node associated with the service data in a decision forest, the decision forest includes at least one decision tree, the decision tree includes at least one burst node and at least two leaf nodes, and the device includes: an analysis unit, configured to analyze, based on the service data and the splitting criterion, a possibility that a leaf node in the decision forest can be matched; a determining unit, configured to: if it is possible that the leaf node can be matched, determine a first data selection value corresponding to the leaf node; and a transfer unit, configured to perform oblivious transfer with a model owner by using the first data selection value as an input, to obtain first data as target data, where the target data is used to determine a prediction result of the decision forest.

According to a ninth aspect of one or more implementations of the present specification, an electronic device is provided, including: a memory, configured to store computer instructions; and a processor, configured to execute the computer instructions to implement method steps according to the seventh aspect.

It can be learned from the previous technical solutions provided in the implementations of the present specification, according to the data processing method provided in the implementations, the splitting criterion of the target burst node is sent to the data owner, the splitting criteria of other burst nodes and the leaf value of the leaf node are saved, and oblivious transfer is performed, so that the data owner obtains the prediction result of the decision forest or the prediction result with limited accuracy, or the model owner obtains the prediction result of the decision forest or the prediction result with limited accuracy, or the model owner and/or the data owner obtain/obtains a comparison in values between the prediction result of the decision forest and the preset threshold, while the model owner does not disclose the decision forest or the service data of the model owner and the data owner does not disclose the service data of the data owner. The target burst node is a burst node associated with the service data in the decision forest.

### BRIEF DESCRIPTION OF DRAWINGS

To describe the technical solutions in the implementations of the present specification or in the existing technology more clearly, the following outlines the accompanying drawings for illustrating such technical solutions. Clearly, the accompanying drawings outlined below are some implementations of the present specification and a person skilled in the art can derive other drawings from such accompanying drawings without creative efforts.

FIG. 1 is a schematic structural diagram illustrating a decision tree, according to an implementation of the present specification;

FIG. 2 is a flowchart illustrating a data processing method, according to an implementation of the present specification;

FIG. 3 is a flowchart illustrating a data processing method, according to an implementation of the present specification;

FIG. 4 is a flowchart illustrating a data processing method, according to an implementation of the present specification;

FIG. 5 is a flowchart illustrating a data processing method, according to an implementation of the present specification;

FIG. 6 is a functional schematic structural diagram illustrating a data processing device, according to an implementation of the present specification;

FIG. 7 is a functional schematic structural diagram illustrating a data processing device, according to an implementation of the present specification;

FIG. 8 is a functional schematic structural diagram illustrating a data processing device, according to an implementation of the present specification;

FIG. 9 is a functional schematic structural diagram illustrating an electronic device, according to an implementation of the present specification.

### DESCRIPTION OF IMPLEMENTATIONS

The technical solutions in the implementations of the present specification are described below clearly and comprehensively with reference to the accompanying drawings in the implementations of the present specification. Clearly, the described implementations are merely some of the implementations of the present specification, rather than all of the implementations. Based on the implementations of the present specification, a person skilled in the art can obtain other implementations without making creative efforts, which all fall within the scope of the present specification. In addition, it should be understood that although terms “first”, “second”, “third”, etc. can be used in the present specification to describe various types of information, the information is not limited to these terms. These terms are only used to differentiate information of a same type. For example, without departing from the scope of the present specification, first information can also be referred to as second information, and similarly, the second information can also be referred to as the first information.

Oblivious transfer (OT) is a duplex protocol for protecting privacy. It allows communication parties to transfer data in a fuzzy selection manner. The sender can have a plurality of pieces of data. The receiver can receive one or more of the plurality of pieces of data through oblivious transfer. In this process, the sender does not know the data received by the receiver; and the receiver cannot obtain any data other than the received data.

Decision tree: a supervised machine learning model. The decision tree can be a binary tree, etc. The decision tree can include a plurality of nodes. Each node can have corresponding location information. The location information is used to identify a location of the node in the decision tree. For example, the location information can be a number of the node. The plurality of nodes can form a plurality of prediction paths. A start node of a prediction path is a root node of the decision tree, and an end node of the prediction path is a leaf node of the decision tree.

The decision tree can include a regression decision tree and a classification decision tree. A prediction result of the regression decision tree can be a specific numerical value. A prediction result of the classification decision tree can be a specific category. It is worthwhile to note that, for ease of computation, a category is usually indicated by a vector. For example, vector [1 0 0] can indicate category A, vector [0 1 0] can indicate category B, and vector [0 0 1] can indicate category C. Certainly, the vectors are only examples. In actual applications, a category can be indicated by using another mathematic method.

Burst node: When a node in a decision tree can be downstream split, the node can be referred to as a burst node. The burst node can include a root node or a node other than a leaf node and a root node. The burst node corresponds to a splitting criterion and a type of data, and the splitting criterion can be used to select a prediction path, and a data type is used to indicate a type of data corresponding to the splitting criterion.

Leaf node: When a node in a decision tree cannot be downstream split, the node can be referred to as a leaf node. Each leaf node corresponds to a leaf value. Different leaf nodes in a decision tree can have a same or different corresponding leaf values. Each leaf node can indicate a precision result. The leaf node can be a numerical value, a vector, etc. For example, a leaf value corresponding to a leaf node of the regression decision tree can be a numerical value, and a leaf value corresponding to a leaf node of the classification decision tree can be a vector.

To facilitate understanding of the previous terms, the following describes an example scenario.

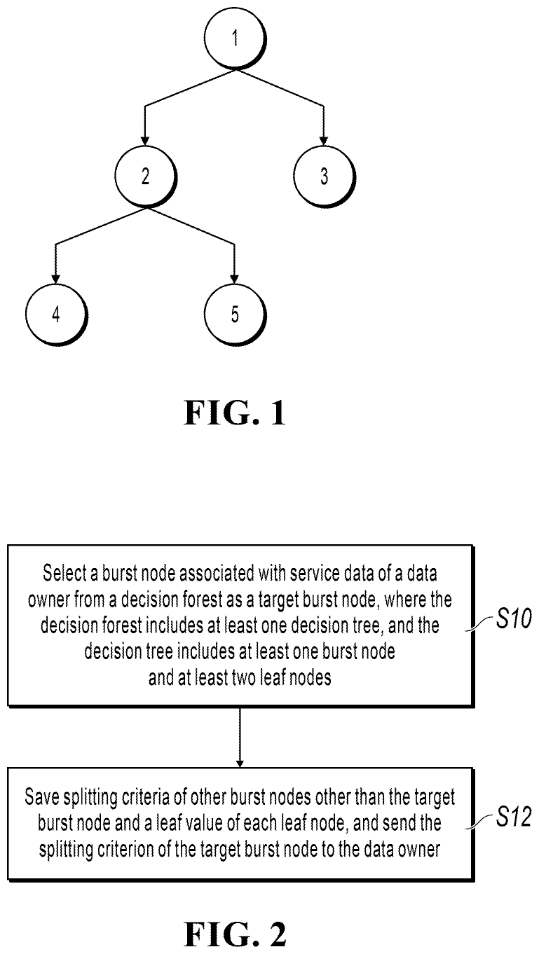

Refer to FIG. 1. In the example scenario, decision tree Tree1 can include five nodes: nodes 1, 2, 3, 4, and 5. Location information of nodes 1, 2, 3, 4, and 5 can be 1, 2, 3, 4, and 5, respectively. Node 1 is a root node; nodes 1, 2, and 3 are burst nodes; and nodes 3, 4, and 5 are leaf nodes. Nodes 1, 2, and 4 can form a prediction path; nodes 1, 2, and 5 can form another prediction path; and nodes 1 and 3 can form still another prediction path.

Splitting criteria corresponding to nodes 1, 2, and 3 are shown in Table 1.

TABLE 1

| Burst node | Splitting criterion | Data type |
|---|---|---|
| 1 | The age is over 20 years. | Age |
| 2 | The annual income is | Income |
| | over 50,000 yuan. | |

Leaf values corresponding to nodes 3, 4, and 5 are shown in Table 2.

TABLE 2

| Leaf node | Leaf value |
|---|---|
| 3 | 200 |
| 4 | 700 |
| 5 | 500 |

In Tree1, the splitting criteria “the age is over 20 years” and “the annual income is over 50,000 yuan” can be used to select a prediction path. When the splitting criterion is met, the prediction path on the left can be selected; when the splitting criterion is not met, the prediction path on the right can be selected. Specifically, for node 1, when the splitting criterion “the age is over 20 years” is met, the prediction path on the left can be selected, and then node 2 is jumped to; or when the splitting criterion “the age is over 20 years” is not met, the prediction path on the right can be selected, and then node 3 is jumped to. Specifically, for node 2, when the splitting criterion “the annual income is over 50,000 yuan” is met, the prediction path on the left can be selected, and then node 4 is jumped to; or when the splitting criterion “the annual income is over 50,000 yuan” is not met, the prediction path on the right can be selected, and then node 5 is jumped to.

One or more decision trees can form a decision forest. The decision forest can include a regression decision forest and a classification decision forest. The regression decision forest can include one or more regression decision trees. When the regression decision forest includes one regression decision tree, the prediction result of the regression decision tree can be used as the prediction result of the regression decision forest. When the regression decision forest includes a plurality of regression decision trees, summation can be performed on the prediction results of the plurality of regression decision trees, and the summation result can be used as the prediction result of the regression decision forest. The classification decision forest can include one or more classification decision trees. When the classification decision forest includes one classification decision tree, the prediction result of the classification decision tree can be used as the prediction result of the classification decision forest. When the classification decision forest includes a plurality of classification decision trees, statistical collection can be performed on the prediction results of the plurality of classification decision trees, and the result of the statistical collection can be used as the prediction result of the classification decision forest. It is worthwhile to note that, in some scenarios, the prediction result of the classification decision tree can be a vector, and the vector can be used to indicate a category. As such, summation can be performed on the prediction results of the plurality of classification decision trees, and the summation result can be used as the prediction result of the classification decision forest. For example, a classification decision tree can include the following decision trees: Tree2, Tree 3, Tree4. The prediction result of Tree2 can be vector [1 0 0], and [1 0 0] indicates category A. The prediction result of Tree3 can be vector [0 1 0], and [0 1 0] indicates category B. The prediction result of Tree4 can be vector [1 0 0], and [0 0 1] indicates category C. Then, summation can be performed on [1 0 0], [0 1 0], and [1 0 0], and the obtained vector [2 1 0] can be used as the prediction result of the classification decision forest. Vector [2 1 0] indicates that the quantity of times that the prediction result of the classification decision forest is category A is 2, the quantity of times that the prediction result of the classification decision forest is category B is 1, and the quantity of times that the prediction result of the classification decision forest is category C is 0.

The present specification provides an implementation of a data processing system.

The data processing system can include a model owner and a data owner. Both the model owner and the data owner can be a server, a mobile phone, a tablet computer, a personal computer, etc. Alternatively, both the model owner and the data owner can be a system including a plurality of devices, for example, a server cluster including a plurality of servers. The model owner has a model that needs to be kept secret and a part of all service data, and the data owner has another part of all service data that needs to be kept secret. For example, the model owner has transaction service data, and the data owner has loan service data. The model owner and the data owner can perform collaborative computation, so that the model owner and/or the data owner obtain/obtains a prediction result obtained by predicting all the service data based on the decision forest. In this process, the model owner cannot disclose its decision forest and service data, and the data owner cannot disclose its service data.

Refer to FIG. 2. Based on the previous data processing system implementation, the present specification provides an implementation of a data processing method. In actual applications, the implementation is applied to a pre-processing phase. The execution entity of the implementation is a model owner. The implementation can include the following steps.

Step S10: Select a burst node associated with service data of a data owner from a decision forest as a target burst node, where the decision forest includes at least one decision tree, and the decision tree includes at least one burst node and at least two leaf nodes.

In some implementations, that the burst node is associated with the service data of the data owner can be understood as: a data type corresponding to the burst node is the same as a data type of the service data of the data owner. The model owner can pre-obtain the data type of the service data of the data owner. As such, the model owner can select, from the decision forest, a burst node whose corresponding data type is the same as the data type of the service data of the data owner as a target burst node. There are one or more target burst nodes.

Step S12: Save splitting criteria of other burst nodes other than the target burst node and a leaf value of each leaf node, and send the splitting criterion of the target burst node to a data owner.

In some implementations, the model owner can send the splitting criterion of the target burst node to the data owner, but cannot send splitting criteria of other burst nodes other than the target burst node and a leaf value of each leaf node. The data owner can receive the splitting criterion of the target burst node, but cannot receive splitting criteria of other burst nodes other than the target burst node and a leaf value of each leaf node, thereby protecting privacy of the decision forest.

In some implementations, the model owner can send location information of a burst node and the location information of a leaf node in the decision forest to the data owner. The data owner can receive the location information of the burst node and the location information of the leaf node in the decision forest; and reconstruct the topology of the decision tree in the decision forest based on the location information of the burst node and the location information of leaf node in the decision forest. The topology of the decision tree can include a connection relationship between the burst node and the leaf node in the decision tree.

According to the data processing method provided in this implementation, the model owner can select a burst node associated with service data of the data owner from a decision forest as a target burst node, save splitting criteria of other burst nodes other than the target burst node and a leaf value of each leaf node, and send the splitting criterion of the target burst node to a data owner. As such, the privacy of the decision forest is protected. In addition, all the service data can be easily predicted based on the decision forest.

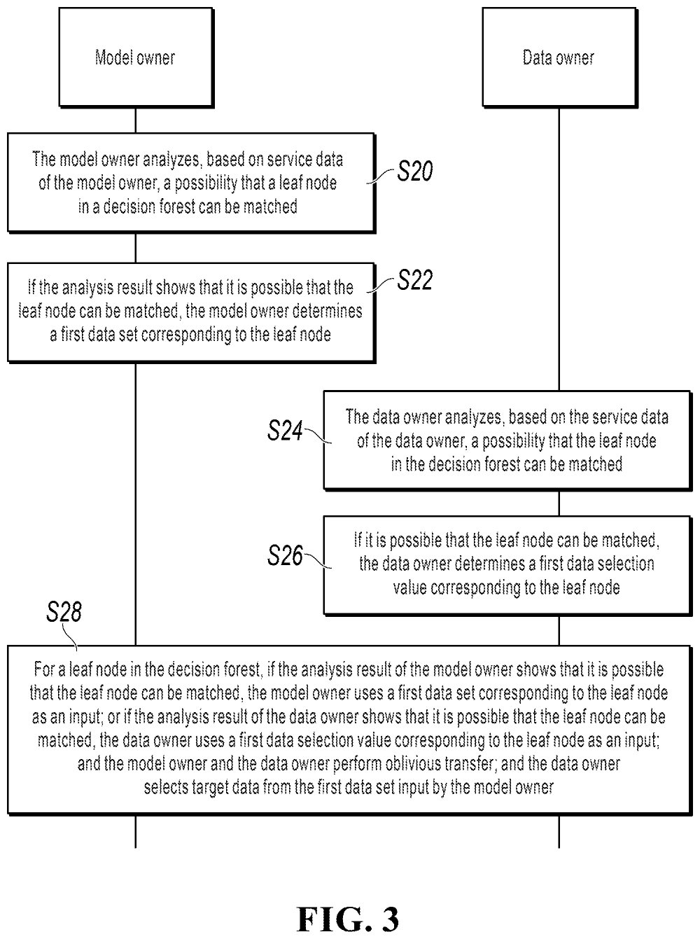

Refer to FIG. 3. Based on the previous data processing system implementation, the present specification provides another implementation of a data processing method. This implementation is applied to the prediction phase, and can include the following steps.

Step S20: A model owner analyzes, based on service data of the model owner, a possibility that a leaf node in a decision forest can be matched.

In some implementations, the decision forest can include at least one decision tree, and the decision tree can include at least one burst node and at least two leaf nodes. The model owner can determine whether each burst node in the decision forest is associated with the service data of the model owner. If yes, the burst node can be used as a first-type burst node; if no, the burst node can be used as a second-type burst node. That the burst node is associated with the service data of the model owner can be understood as: a data type corresponding to the burst node is the same as a data type of the service data of the model owner.

In some implementations, the leaf value of each leaf node in the decision tree can indicate a prediction result. If one leaf node in the decision tree can be matched, the leaf value of the leaf node can be used as the prediction result of the decision tree.

The nodes of each decision tree in the decision forest can form a plurality of prediction paths, where each prediction path can include at least one burst node and one leaf node. As such, the model owner can determine, based on the service data of the model owner and the splitting criterion of the burst node in the prediction path, a possibility that the leaf node in the prediction path can be matched. The possibility that the leaf node can be matched can include: possibly matched and impossibly matched. It is worthwhile to note that the decision tree includes at least one leaf node that is possibly matched, according to the analysis result of the model owner. There are two cases: 1) All the leaf nodes in the decision tree are possibly matched, according to the analysis result of the model owner; 2) some leaf nodes in the decision tree are possibly matched, and some other leaf nodes in the decision tree are impossibly matched, according to the analysis result of the model owner.

In actual applications, if all the burst nodes in a prediction path are first-type burst nodes, and the service data of the model owner does not meet the splitting criterion of at least one burst node in the prediction path, the model owner can determine that it is impossible that the leaf node in the prediction path can be matched; otherwise, the model owner can determine that it is possible that the leaf node in the prediction path can be matched.

That it is possible that the leaf node can be matched can further include: the leaf node can be matched, and it is uncertain whether the leaf node can be matched.

In actual applications, if all the burst nodes in a prediction path are first-type burst nodes, the model owner can determine whether the service data of the model owner meets the splitting criteria of all burst nodes in the prediction path. If yes, the model owner can determine that the leaf node in the prediction path can be matched; otherwise, the model owner can determine that it is impossible that the leaf node in the prediction path can be matched. In addition, if all the burst nodes in a prediction path are second-type burst nodes, or some burst nodes are first-type burst nodes, and some other burst nodes are second-type burst nodes, the model owner can determine that it is uncertain whether the leaf node in the prediction path can be matched.

Step S22: If the analysis result shows that it is possible that the leaf node can be matched, the model owner determines a first data set corresponding to the leaf node.

In some implementations, the data owner can generate a random number for each burst node in the decision forest. The sum of the random numbers of all the leaf nodes in the decision forest is a specific value. The specific value can be a completely random number, for example, a random number r. Alternatively, the specific value can be a fixed value 0. For example, the decision forest can include k leaf nodes. The model owner can generate k-1 random numbers r₁, r₂, . . . , rᵢ, . . . , rₖ₋₁ for the k-1 leaf nodes, and can compute rₖ=0−(r₁+r₂+ . . . +rᵢ+ . . . +rₖ₋₁) as a random number corresponding to the k^{th} leaf node. Alternatively, the specific value can be preset noise data (hereafter referred to as first noise data). For example, the decision forest can include k leaf nodes. The model owner can generate k-1 random numbers r₁, r₂, . . . , rᵢ, . . . , rₖ₋₁ for the k-1 leaf nodes, and can compute rₖ=s1−(r₁+r₂+ . . . +rᵢ+ . . . +rₖ₋₁) as a random number corresponding to the k^{th} leaf node. s1 indicates the first noise data.

In some implementations, a first data set can include a leaf value ciphertext and a random number. Data in the first data set is in a specific order. For example, the leaf value ciphertext can be first data in the first data set, and the random number can be second data in the first data set. Certainly, based on actual demands, the random number can be first data in the first data set, and the leaf value ciphertext can be second data in the first data set.

For each leaf node in the decision forest, if it is possible that the leaf node can be matched, the model owner can encrypt the leaf value of the leaf node by using the random number of the leaf node as a random number in the first data set, and use an obtained leaf value ciphertext as a leaf value ciphertext in the first data set. The model owner can use the random number of the leaf node to encrypt the leaf value of the leaf node. This implementation does not limit the encryption manner. For example, the random number and the leaf value can be added up.

Step S24: The data owner analyzes, based on the service data of the data owner, a possibility that the leaf node in the decision forest can be matched.

In some implementations, a burst node in the decision forest is associated with either the service data of the model owner or the service data of the data owner. As such, the data owner can determine whether a burst node in the decision forest is associated with the service data of the data owner. If yes, the burst node can be used as a second-type burst node; if no, the burst node can be used as a first-type burst node. That the burst node is associated with the service data of the data owner can be understood as: a data type corresponding to the burst node is the same as a data type of the service data of the data owner. In actual applications, the data owner has a splitting criterion of a burst node associated with the service data of the data owner, and does not have a splitting criterion of any other burst node. Therefore, the data owner can directly use a burst node with a corresponding splitting criterion as a second-type burst node, and use a burst node without a corresponding splitting criterion as a first-type burst node.

In some implementations, as described above, the nodes of each decision tree in the decision forest can form a plurality of prediction paths, where each prediction path can include at least one burst node and one leaf node. As such, the data owner can determine, based on the service data of the data owner and the splitting criterion of the burst node in the prediction path, a possibility that the leaf node in the prediction path can be matched. The possibility that the leaf node can be matched can include: possibly matched and impossibly matched. It is worthwhile to note that the decision tree includes at least one leaf node that is possibly matched, according to the analysis result of the data owner. There are two cases: 1) All the leaf nodes in the decision tree are possibly matched, according to the analysis result of the data owner; 2) some leaf nodes in the decision tree are possibly matched, and some other leaf nodes in the decision tree are impossibly matched, according to the analysis result of the data owner. It is also worthwhile to note that if both the analysis result of the model owner and the analysis result of the data owner show that it is possible that a leaf node can be matched, it is determined that the leaf node matches all the service data; otherwise, it can be determined that the leaf node does not match all the service data.

In actual applications, if all the burst nodes in a prediction path are second-type burst nodes, and the service data of the data owner does not meet the splitting criterion of at least one burst node in the prediction path, the data owner can determine that it is impossible that the leaf node in the prediction path can be matched; otherwise, the data owner can determine that it is possible that the leaf node in the prediction path can be matched.

That it is possible that the leaf node can be matched can further include: the leaf node can be matched, and it is uncertain whether the leaf node can be matched.

In actual applications, further, if all the burst nodes in a prediction path are second-type burst nodes, the data owner can determine whether the service data of the data owner meets the splitting criteria of all burst nodes in the prediction path. If yes, the data owner can determine that it is possible that the leaf node in the prediction path can be matched; otherwise, the data owner can determine that it is impossible that the leaf node in the prediction path can be matched. In addition, if all the burst nodes in a prediction path are first-type burst nodes, or some burst nodes are second-type burst nodes, and some other burst nodes are first-type burst nodes, the data owner can determine that it is uncertain whether the leaf node in the prediction path can be matched.

Step S26: If it is possible that the leaf node can be matched, the data owner determines a first data selection value corresponding to the leaf node.

In some implementations, as an input of the data owner during oblivious transfer, a data selection value can be used to select target data from a data set that is input by the model owner during oblivious transfer. Data selection values can include a first data selection value and a second data selection value. The first data selection value can be used to select first data from the data set as target data, and the second data selection value can be used to select second data from the data set as target data. Certainly, based on actual demands, the first data selection value can be used to select second data from the data set as target data, and the second data selection value can be used to select first data set from the data set as target data. For example, the first data selection value can be 1, and the second data selection value can be 2.

In some implementations, for a leaf node in the decision forest, if the analysis result shows that it is possible that the leaf node can be matched, the data owner can determine a first data selection value as a data selection value corresponding to the leaf node; or if the analysis result shows that it is impossible that the leaf node can be matched, the data owner can determine a second data selection value as a data selection value corresponding to the leaf node.

Step S28: For a leaf node in the decision forest, if the analysis result of the model owner shows that it is possible that the leaf node can be matched, the model owner uses a first data set corresponding to the leaf node as an input; or if the analysis result of the data owner shows that it is possible that the leaf node can be matched, the data owner uses a first data selection value corresponding to the leaf node as an input; and the model owner and the data owner perform oblivious transfer. The data owner selects target data from the first data set.

In some implementations, for a leaf node in the decision forest, if the analysis result of the model owner shows that it is possible that the leaf node can be matched, the model owner can use a first data set corresponding to the leaf node as an input; or if the analysis result of the data owner shows that it is possible that the leaf node can be matched, the data owner can use a first data selection value as an input, or if the analysis result of the data owner shows that it is impossible that the leaf node can be matched, the data owner can use a second data selection value corresponding to the leaf node as an input; and the model owner and the data owner perform oblivious transfer. The data owner can select target data from the first data set. As such, if both the analysis result of the model owner and the analysis result of the data owner show that it is possible that a leaf node can be matched, the data owner selects a leaf value ciphertext from the first data set as the target data; otherwise, the data owner selects a random number from the first data set as the target data. Based on features of oblivious transfer, the model owner does not know the data that is selected by the data owner as the target data, and the data owner does not know any data other than the selected target data.

In some implementations, for a leaf node in the decision forest, if the analysis result shows that it is impossible that the leaf node can be matched, the model owner can determine a second data set corresponding to the leaf node. The second data set can include two identical random numbers. Specifically, the model owner can use the random number of the leaf node as a random number in the second data set.

In some implementations, for a leaf node in the decision forest, if the analysis result of the model owner shows that it is impossible that the leaf node can be matched, the model owner can use a second data set corresponding to the leaf node as an input; or if the analysis result of the data owner shows that it is possible that the leaf node can be matched, the data owner can use a first data selection value corresponding to the leaf node as an input, or if the analysis result of the data owner shows that it is impossible that the leaf node can be matched, the data owner can use a second data selection value corresponding to the leaf node as an input; and the model owner and the data owner perform oblivious transfer; and the model owner and the data owner perform oblivious transfer. The data owner can select target data from the second data set. Because the second data set includes two identical random numbers, if one of or both the analysis result of the model owner and the analysis result of the data owner show that it is impossible that the leaf node can be matched, the data owner selects a random number from the second data set as the target data. Based on features of oblivious transfer, the model owner does not know the data that is selected by the data owner as the target data, and the data owner does not know any data other than the selected target data.

In some implementations, that it is possible that the leaf node can be matched can further include: the leaf node can be matched, and it is uncertain whether the leaf node can be matched. As such, in step S22, for a leaf node in the decision forest, if the analysis result of the model owner shows that it is uncertain whether the leaf node can be matched, the model owner can determine a first data set corresponding to the leaf node; or if the analysis result of the data owner shows that the leaf node can be matched, the data owner can encrypt the leaf value of the leaf node, to obtain a leaf value ciphertext; or if the analysis result of the model owner shows that it is impossible that the leaf node can be matched, the model owner can determine a random number corresponding to the leaf node. Specifically, the model owner can use the random number of the leaf node to encrypt the leaf value of the leaf node. This implementation does not limit the encryption manner. For example, the random number and the leaf value can be added up. In addition, the model owner can use the random number of the leaf node as the random number corresponding to the leaf node.

In step S28, for a leaf node in the decision forest, if the analysis result of the model owner shows that it is possible that the leaf node can be matched, the model owner can use a first data set corresponding to the leaf node as an input; or if the analysis result of the data owner shows that it is possible that the leaf node can be matched, the data owner can use a first data selection value corresponding to the leaf node as an input, or if the analysis result of the data owner shows that it is impossible that the leaf node can be matched, the data owner can use a second data selection value corresponding to the leaf node as an input; and the model owner and the data owner perform oblivious transfer. The data owner can select target data from the first data set. In addition, if the analysis result of the model owner shows that the leaf node can be matched, the model owner can directly send the leaf value ciphertext of the leaf node to the data owner, and the data owner can receive the leaf value ciphertext as the target data; or if the analysis result of the model owner shows that it is impossible that the leaf node can be matched, the model owner can directly send the random number corresponding to the leaf node to the data owner, and the data owner can receive the random number as the target data.

As such, the quantity of times of oblivious transfer is reduced, and prediction efficiency is improved.

In some implementations, in some cases, the model owner can select, from the decision forest, a decision tree whose all burst nodes are associated with the service data of the model owner as the target decision tree; Because all burst nodes in the target decision tree are associated with the service data of the model owner, the model owner can use the target decision tree to predict the service data of the model owner, to obtain the prediction result of the target decision tree; and the model owner can encrypt the prediction result of the target decision tree, and send the obtained prediction result ciphertext to the data owner. The data owner can receive the prediction result ciphertext as the target data. The prediction result of the target decision tree can include the leaf value of a matched leaf node in the target decision tree. The prediction result ciphertext of the target decision tree can include the leaf value ciphertext that is obtained by encrypting the leaf value. The model owner can use the random number of the leaf node to encrypt the leaf value of the leaf node. This implementation does not limit the encryption manner. For example, the model owner can add up the random number and the leaf value.

As such, the quantity of times of oblivious transfer is reduced, and prediction efficiency is improved.

In some implementations, the target data can be used to determine a prediction result of a decision forest.

In some implementations, the data owner can obtain the prediction result of the decision forest or the prediction result with first noise data (a prediction result with limited accuracy). The prediction with the first noise data can be understood as: the prediction result and the first noise data are added up.

The data owner can add up all the target data, to obtain the prediction result of the decision forest or the prediction result with the first noise data. As described above, the model owner can generate a random number for each leaf node in the decision forest. The sum of the random numbers of all the leaf nodes in the decision forest is a specific value. As such, when the specific value is a fixed value 0, the data owner can add up all the target data to obtain the prediction result of the decision forest. As such, when the specific value is the first noise data, the data owner can add up all the target data to obtain the prediction result with the first noise data of the decision forest.

In some implementations, the model owner can obtain the prediction result of the decision forest or the prediction result with second noise data (another prediction result with limited accuracy). The size of the second noise data can be flexibly set as required, which is usually less than the size of all the service data. The prediction with the second noise data can be understood as: the prediction result and the second noise data are added up.

The data owner can add up all the target data to obtain a first summation result, and can send the first summation result to the model owner. The model owner can receive the first summation result, and can compute the prediction result of the decision forest based on the first summation result. As described above, the model owner can generate a random number for each leaf node in the decision forest. The sum of the random numbers of all the leaf nodes in the decision forest is a specific value. As such, when the specific value is a completely random number r, because the model owner knows the random number r, the model owner can compute the prediction result u of the decision forest based on the first summation result u+r.

Alternatively, the data owner can add up all the target data to obtain a first summation result, can add up the first summation result and the second noise data to obtain a second summation result, and can send the second summation result to the model owner. The model owner can receive the second summation result, and can compute the prediction result with the second noise data of the decision forest based on the second summation result. As described above, the model owner can generate a random number for each leaf node in the decision forest. The sum of the random numbers of all the leaf nodes in the decision forest is a specific value. As such, when the specific value is a completely random number r, the data owner can add up the first summation result u+r and the second noise data s2, to obtain the second summation result u+r+s2. Because the model owner knows the random number r, the model owner can compute the prediction result u+s2 with the second noise data of the decision forest based on the second summation result u+r+s2.

In some implementations, the model owner and/or the data owner can obtain a comparison in values between the prediction result of the decision forest and a preset threshold. The preset threshold can be flexibly set as required. In actual applications, the preset threshold can be a threshold value. When the prediction value is greater than the preset threshold, a preset operation can be performed; or when the preset value is less than the preset threshold, another preset operation can be performed. For example, the preset value can be a threshold value used in the risk evaluation business. The predication result of the decision forest can be a credit score of a user. When the credit score of a user is greater than the preset threshold, it indicates that the risk level of the user is high, and the loan request of the user can be rejected; or when the credit score of the user is less than the preset threshold, it indicates that the risk level of the user is low, and the loan request of the user can be approved. It is worthwhile to note that, in this implementation, the model owner and the data owner only know the preset threshold and the comparison in values between the prediction result and the preset threshold, but cannot know the specific prediction result of the decision forest.

As described above, the model owner can generate a random number for each leaf node in the decision forest. The sum of the random numbers of all the leaf nodes in the decision forest is a specific value. The specific value can be a completely random number r. As such, all the target data can be added up by the data owner, to obtain the first summation result u+r. The data owner can use the first summation result u+r as an input, and the model owner can use the random number r and the preset threshold t as an input, to collaboratively perform a secure multi-party comparison algorithm. Based on execution of the secure multi-party comparison algorithm, the model owner and/or the data owner can obtain the comparison in values between the prediction result u of the decision forest and the preset threshold while the data owner does not disclose the first summation result u+r and the model owner does not disclose the random number r. It is worthwhile to note that any existing secure multi-party comparison algorithm can be used here. A specific process is not described here.

According to the data processing method provided in the implementations, the splitting criterion of the target burst node is sent to the data owner, the splitting criteria of other burst nodes and the leaf value of the leaf node are saved, and oblivious transfer is performed, so that the data owner obtains the prediction result of the decision forest or the prediction result with limited accuracy, or the model owner obtains the prediction result of the decision forest or the prediction result with limited accuracy, or the model owner and/or the data owner obtain/obtains a comparison in values between the prediction result of the decision forest and the preset threshold, while the model owner does not disclose the decision forest or the service data of the model owner and the data owner does not disclose the service data of the data owner. The target burst node is a burst node associated with the service data in the decision forest.

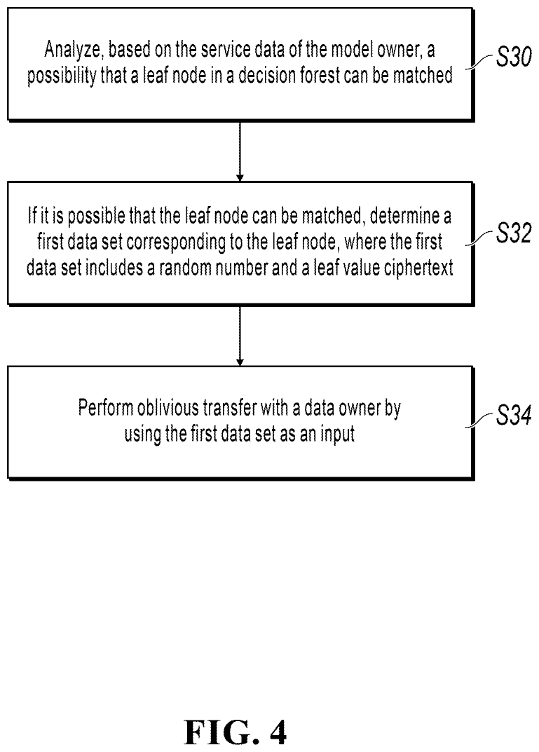

Refer to FIG. 4. Based on the same inventive concept, the present specification provides another implementation of a data processing method. The execution entity of the implementation is a model owner. The implementation can include the following steps.

Step S30: Analyze, based on the service data of the model owner, a possibility that a leaf node in a decision forest can be matched.

Step S32: If it is possible that a leaf node can be matched, determine a first data set corresponding to the leaf node, where the first data set includes a random number and a leaf value ciphertext.

Step S34: Perform oblivious transfer with a data owner by using the first data set as an input.

For a specific process of steps S30, S32, and S34, references can be made to the implementation corresponding to FIG. 2. Details are omitted here for simplicity.

According to the data processing method provided in this implementation, the model owner can send transfer/send data required for prediction to the data owner without disclosing the decision forest and the service data of the model owner, to predict all the service data by using the decision forest.

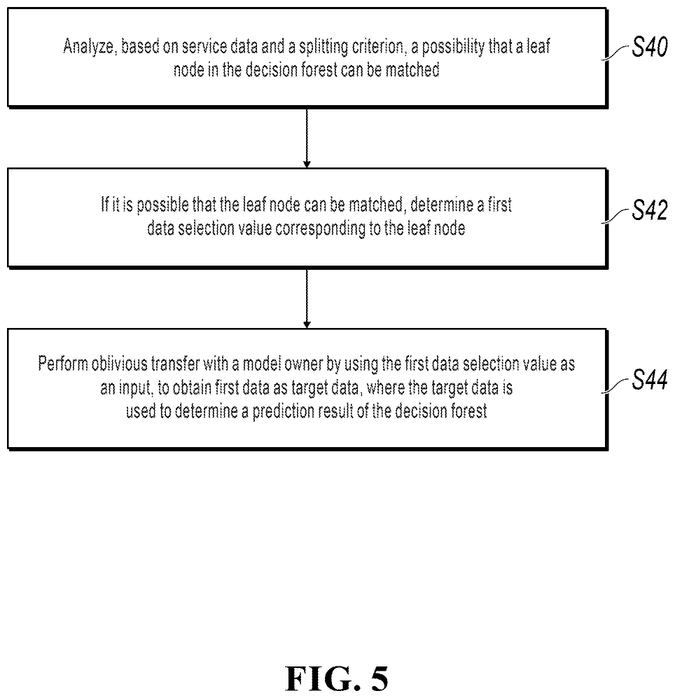

Refer to FIG. 5. Based on the same inventive concept, the present specification provides another implementation of a data processing method. The execution entity of the implementation is a data owner. The data owner has service data and a splitting criterion corresponding to a target burst node, the target burst node is a burst node associated with the service data in a decision forest, the decision forest includes at least one decision tree, and the decision tree includes at least one burst node and at least two leaf nodes. This implementation can include the following steps.

Step S40: Analyze, based on the service data and the splitting criterion, a possibility that a leaf node in the decision forest can be matched.

Step S42: If it is possible that the leaf node can be matched, determine a first data selection value corresponding to the leaf node.

Step S44: Perform oblivious transfer with a model owner by using the first data selection value as an input, to obtain first data as target data, where the target data is used to determine a prediction result of the decision forest.

In some implementations, the first data can be selected from a leaf value ciphertext and a random number.

In some implementations, if the analysis result shows that it is impossible that the leaf node can be matched, the data owner can determine a second data selection value corresponding to the data owner, and can perform oblivious transfer with the model owner by using the second data selection value as an input, to obtain second data as target data. The second data can be selected from a leaf value ciphertext and a random number.

In some implementations, alternatively, the data owner can receive third data of the leaf node from the model owner as the target data. The third data can be selected from a leaf value ciphertext and a random number.

In some implementations, alternatively, the data owner can receive fourth data of the decision tree from the model owner as the target data. The fourth data can include a prediction result ciphertext.

In some implementations, the data owner can add up all the target data, to obtain the prediction result of the decision forest or the prediction result with the first noise data.

In some implementations, the data owner can add up all the target data, to obtain a first summation result; and can send the first summation result to the model owner, so that the model owner determines the prediction result of the decision forest based on the first summation result; or can add up the first summation result and second noise data to obtain a second summation result, and then send the second summation result to the model owner, so that the model owner determines the prediction result with the second noise data of the decision forest based on the second summation result.

In some implementations, the data owner can add up all the target data to obtain a first summation result; and can collaboratively execute a secure multi-party comparison algorithm with the model owner by using the first summation result as an input, to compare the prediction result of the decision forest and a preset threshold.

According to the data processing method in this implementation, the data owner can use the data required for prediction that is transferred/sent by the model owner, to obtain the prediction result of the decision forest, the prediction result with limited accuracy of the decision forest, or the comparison in values between the prediction result of the decision forest and the preset threshold, while the data owner does not disclose the service data of the data owner.

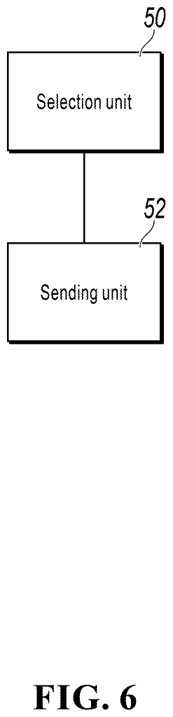

Refer to FIG. 6. The present specification further provides an implementation of a data processing device. The data processing device can be disposed on a model owner. The device can include the following units: a selection unit 50, configured to select a burst node associated with service data of a data owner from a decision forest as a target burst node, where the decision forest includes at least one decision tree, and the decision tree includes at least one burst node and at least two leaf nodes; and a sending unit 52, configured to save splitting criteria of other burst nodes other than the target burst node and a leaf value of each leaf node, and send the splitting criterion of the target burst node to a data owner.

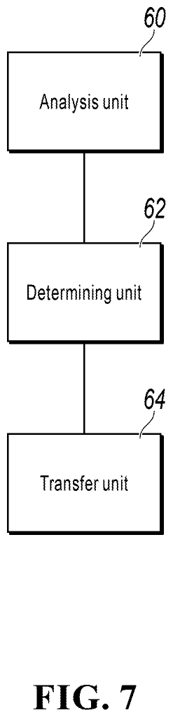

Refer to FIG. 7. The present specification further provides an implementation of a data processing device. The data processing device can be disposed on a model owner. The data owner has service data. The device can include the following units: an analysis unit 60, configured to analyze, based on the service data, a possibility that a leaf node in a decision forest can be matched, where the decision forest includes at least one decision tree, and the decision tree includes at least one burst node and at least two leaf nodes; a determining unit 62, configured to: if it is possible that the leaf node can be matched, determine a first data set corresponding to the leaf node, where the first data set includes a random number and a leaf value ciphertext; and a transfer unit 64, configured to perform oblivious transfer with a data owner by using the first data set as an input.

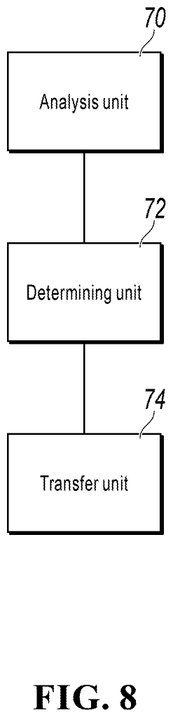

Refer to FIG. 8. The present specification further provides an implementation of a data processing device. The data processing device can be disposed on a data owner. The data owner has service data and a splitting criterion corresponding to a target burst node, and the target burst node is a burst node associated with the service data in a decision forest. The decision forest includes at least one decision tree, and the decision tree includes at least one burst node and at least two leaf nodes. The device can include the following units: an analysis unit 70, configured to analyze, based on the service data and the splitting criterion, a possibility that a leaf node in the decision forest can be matched; a determining unit 72, configured to: if it is possible that the leaf node can be matched, determine a first data selection value corresponding to the leaf node; and a transfer unit 74, configured to perform oblivious transfer with a model owner by using the first data selection value as an input, to obtain first data as target data, where the target data is used to determine a prediction result of the decision forest.

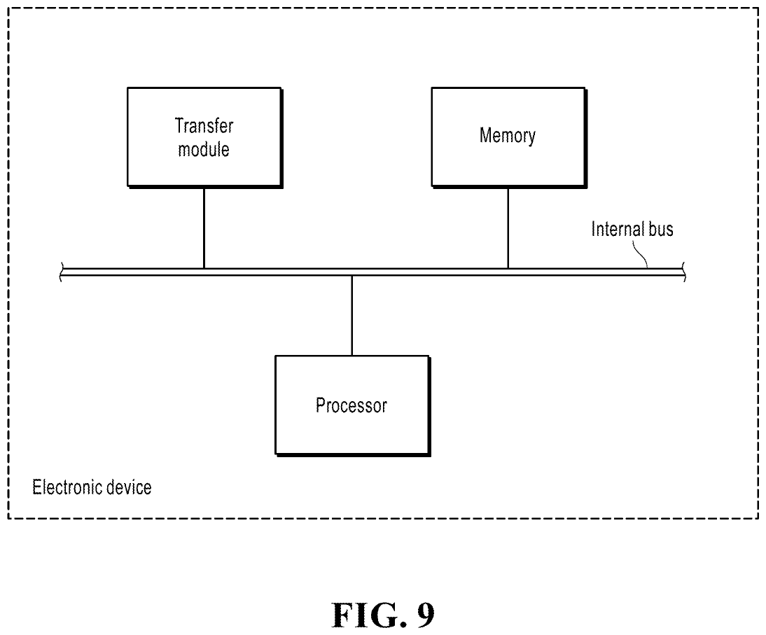

The following describes one implementation of an electronic device provided in the present specification. FIG. 9 is a schematic diagram illustrating a hardware structure of an electronic device provided in an implementation of the present specification. As shown in FIG. 9, the electronic device can include one or more processors (only one processor is shown), memories, and transfer modules. Certainly, a person of ordinary skill in the art should understand that the hardware structure shown in FIG. 9 is merely an example and does not constitute any limitation on the hardware structure of the electronic device. In practice, the electronic device can include more or fewer components than those shown in FIG. 9; or have a configuration different than that shown in FIG. 9.

The memory can include a high-speed random access memory; or can include a nonvolatile memory, such as one or more magnetic storage devices, a flash memory, or another nonvolatile solid-state memory. Certainly, the memory can alternatively include a remote network memory. The remote network memory can be connected to the electronic device through the Internet, an enterprise intranet, a local area network, a mobile communications network, etc. The memory can be configured to store program instructions or modules of application software, such as program instructions or modules of the implementation corresponding to FIG. 2 in the present specification, program instructions or modules of the implementation corresponding to FIG. 4, or program instructions or modules of the implementation corresponding to FIG. 5.

The processor can be implemented by using an appropriate method. For example, the processor can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or a built-in microprocessor. The processor can read and execute program instructions or modules in the memory.

The transfer module can be configured to transfer data through a network, for example, through the Internet, an enterprise intranet, a local area network, or a mobile communications network.

It is worthwhile to note that the implementations of the present specification are described in a progressive way. For same or similar parts of the implementations, mutual references can be made to the implementations. Each implementation focuses on a difference from the other implementations. Particularly, a device implementation and an electronic device implementation are basically similar to a data processing method implementation, and therefore are described briefly. For related parts, references can be made to related descriptions in the data processing method implementation.

In addition, it should be understood that, after reading the present specification, a person skilled in the art can freely combine some or all of the implementations in the present specification without creative efforts, and such combinations shall fall within the protection scope of the present specification.

In the 1990s, whether technology improvement is hardware improvement (for example, improvement of a circuit structure, such as a diode, a transistor, or a switch) or software improvement (improvement of a method procedure) can be obviously distinguished. However, as technologies develop, the current improvement for many method procedures can be considered as a direct improvement of a hardware circuit structure. A designer usually programs an improved method procedure to a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, the programming is mostly implemented by modifying “logic compiler” software instead of manually making an integrated circuit chip. This is similar to a software compiler used for program development and compiling. However, original code before compiling is also written in a specific programming language, which is referred to as a hardware description language (HDL). There are many HDLs, such as an Advanced Boolean Expression Language (ABEL), an Altera Hardware Description Language (AHDL), Confluence, a Cornell University Programming Language (CUPL), HDCal, a Java Hardware Description Language (JHDL), Lava, Lola, MyHDL, PALASM, and a Ruby Hardware Description Language (RHDL). Currently, a Very-High-Speed Integrated Circuit Hardware Description Language (VHDL) and Verilog2 are most commonly used. A person skilled in the art should also understand that a hardware circuit that implements a logical method procedure can be readily obtained once the method procedure is logically programmed by using the several described hardware description languages and is programmed into an integrated circuit.

The system, device, module, or unit illustrated in the previous implementations can be implemented by using a computer chip or an entity, or can be implemented by using a product having a certain function. A typical implementation device is a computer. A specific form of the computer can be a personal computer, a laptop computer, a cellular phone, a camera phone, an intelligent phone, a personal digital assistant, a media player, a navigation device, an email transceiver device, a game console, a tablet computer, a wearable device, or any combination thereof.

It can be learned from descriptions of the implementations that a person skilled in the art can clearly understand that the present specification can be implemented by using software in addition to a necessary universal hardware platform. Based on such an understanding, the technical solutions in the present specification essentially or the part contributing to the existing technology can be implemented in a form of a software product. The software product can be stored in a storage medium, such as a ROM/RAM, a magnetic disk, or an optical disc, and includes several instructions for instructing a computer device (such as a personal computer, a server, or a network device) to perform the methods described in the implementations or in some parts of the implementations of the present specification.

The present specification can be used in many general-purpose or dedicated computer system environments or configurations, for example, a personal computer, a server computer, a handheld device, a portable device, a tablet device, a mobile communications terminal, a multiprocessor system, a microprocessor system, a programmable electronic device, a network PC, a small computer, a mainframe computer, and a distributed computing environment including any of the above systems or devices.

The present specification can be described in the general context of computer executable instructions executed by a computer, for example, a program module. Generally, the program module includes a routine, a program, an object, a component, a data structure, etc. executing a specific task or implementing a specific abstract data type. The present specification can also be practiced in distributed computing environments. In the distributed computing environments, tasks are performed by remote processing devices connected through a communications network. In a distributed computing environment, the program module can be located in both local and remote computer storage media including storage devices.

Although the present specification is described by using the implementations, a person of ordinary skill in the art knows that many modifications and variations of the present specification can be made without departing from the spirit of the present specification. It is expected that the claims include these modifications and variations without departing from the spirit of the present specification.

1. (canceled)

2. A computer-implemented method comprising:
determining that a particular leaf node in a decision forest that includes at least one decision tree is likely matched, wherein the decision tree comprises at least one burst node and at least two leaf nodes;
in response to determining that the particular leaf node is likely matched, identifying a first data set that is associated with the particular leaf node, wherein the first data set comprises (i) a random number, and (ii) a leaf value ciphertext; and
performing oblivious transfer with a data owner using the first data set as an input.

3. The method of claim 2, wherein identifying the first data set comprises:
generating a random number for each leaf node in the decision forest.

4. The method of claim 2, comprising encrypting a leaf value associated with the particular leaf node using a random number.

5. The method of claim 2, comprising identifying a second data set that is associated with the particular leaf node.

6. The method of claim 2, comprising transmitting leaf value associated with the particular leaf node to the data owner.

7. The method of claim 2, comprising:
selecting, from the decision forest, a particular decision tree whose burst nodes are associated with service data as a target decision tree.

8. A computer-implemented system, comprising one or more computers, and one or more computer memory devices interoperably coupled with the one or more computers and having tangible, non-transitory, machine-readable media storing one or more instructions that, when executed by the one or more computers, perform operations comprising:
determining that a particular leaf node in a decision forest that includes at least one decision tree is likely matched, wherein the decision tree comprises at least one burst node and at least two leaf nodes;
in response to determining that the particular leaf node is likely matched, identifying a first data set that is associated with the particular leaf node, wherein the first data set comprises (i) a random number, and (ii) a leaf value ciphertext; and
performing oblivious transfer with a data owner using the first data set as an input.

9. The system of claim 8, wherein identifying the first data set comprises:
generating a random number for each leaf node in the decision forest.

10. The system of claim 8, wherein the operations comprise encrypting a leaf value associated with the particular leaf node using a random number.

11. The system of claim 8, wherein the operations comprise identifying a second data set that is associated with the particular leaf node.

12. The system of claim 8, wherein the operations comprise transmitting leaf value associated with the particular leaf node to the data owner.

13. The system of claim 8, wherein the operations comprise:
selecting, from the decision forest, a particular decision tree whose burst nodes are associated with service data as a target decision tree.

14. A non-transitory, computer-readable medium storing one or more instructions executable by a computer system to perform operations comprising:
determining that a particular leaf node in a decision forest that includes at least one decision tree is likely matched, wherein the decision tree comprises at least one burst node and at least two leaf nodes;
in response to determining that the particular leaf node is likely matched, identifying a first data set that is associated with the particular leaf node, wherein the first data set comprises (i) a random number, and (ii) a leaf value ciphertext; and
performing oblivious transfer with a data owner using the first data set as an input.

15. The medium of claim 14, wherein identifying the first data set comprises:
generating a random number for each leaf node in the decision forest.

16. The medium of claim 14, wherein the operations comprise encrypting a leaf value associated with the particular leaf node using a random number.

17. The medium of claim 14, wherein the operations comprise identifying a second data set that is associated with the particular leaf node.

18. The medium of claim 14, wherein the operations comprise transmitting leaf value associated with the particular leaf node to the data owner.

19. The medium of claim 14, wherein the operations comprise:
selecting, from the decision forest, a particular decision tree whose burst nodes are associated with service data as a target decision tree.
